(19) United States
(12) Patent Application Publication
(10) Pub. No.: US 2025/0168842 A1
(43) Pub. Date: May 22, 2025

(54) MANAGEMENT NODE, CONTROLLER NODE AND METHODS IN A WIRELESS COMMUNICATIONS NETWORK

(71) Applicant: Telefonaktiebolaget LM Ericsson (publ), Stockholm (SE)

(72) Inventors: Alexey SHAPIN, Luleå (SE); Hideshi MURAI, Zushi (JP); Leefke GROSJEAN, Täby (SE); Peter DE BRUIN, Gammelstad (SE); Swarup KUMAR MOHALIK, Bangalore (IN)

(21) Appl. No.: 18/840,248

(22) PCT Filed: Mar. 8, 2022
(86) PCT No.: PCT/SE2022/050225

§ 371 Date: Aug. 21, 2024

(51) Int. Cl. H04W 72/121; H04L 41/0893

(52) U.S. Cl. CPC H04W 72/121; H04L 41/0893

(57) ABSTRACT

Handling communication resources allocated to one or more logical groups in a set of logical groups in a wireless communications network is provided. One or more wireless devices is associated to each logical group. A management node allocates a communication resource to each logical group in the set of logical groups. Each wireless device is associated to at least one logical group in the set of logical groups. Each logical group is associated with an operational process in the control facility. The management node monitors the allocated communication resource to perform the operational process associated with the respective logical group. The management node receives a first indication that is related to a first action performed by the controller node. The management node performs a second action taking the received first indication and the monitored communication resource into account to handle communication resources allocated to the one or more logical groups.

### TECHNICAL FIELD

Embodiments herein relate to a management node, a controller node and methods therein. Furthermore, a computer program and a computer readable storage medium are also provided herein. In particular, embodiments herein relate to handling communication resources in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Industry spectrum and wireless resources are scarce, while industry requirements are high and may vary over time, e.g. lights out operation. Also, redundancy requirements may require installation of additional hardware, increasing both capital expenditure (CAPEX) and operating expenses (OPEX). There is a need to manage resources, performance and outcome, potentially including usage of redundant infrastructure in a flexible manner. When moving to wireless factories, the management of network resources becomes even more important.

### SUMMARY

An object of embodiments herein is to improve the flexibility and performance of a wireless communications network.

According to an aspect of embodiments herein, the object is achieved by a method performed by a management node for handling communication resources allocated to one or more logical groups in a set of logical groups in a wireless communications network. The one or more logical groups are controlled by a controller node associated to a control facility. One or more wireless devices is associated to each logical group. The management node allocates a communication resource to each one or more logical groups in the set of logical groups. Each wireless device is associated to at least one logical group in the set of logical groups. Each logical group is associated with an operational process in the control facility. The management node monitors the allocated communication resource, by monitoring an available communication resource, a communication resource currently used, and/or a communication resource required by one or more of the logical groups to perform the operational process associated with the respective logical group. The management node receives a first indication from the controller node. The first indication is related to a first action performed by the controller node. The management node performs a second action taking the received first indication and the monitored communication resource into account. The second action is performed for handling communication resources allocated to the one or more logical groups.

According to another aspect of embodiments herein, the object is achieved by a method performed by a controller node for assisting a management node in handling communication resources allocated to one or more logical groups in a set of logical groups in wireless communications network. The one or more logical groups are controlled by the controller node. The controller node is associated to a control facility. one or more wireless devices is associated to each logical group. The controller node performs a first action. The first action is related to handling communication resources allocated to the one or more logical groups. The controller node sends a first indication to the management node. The first indication is related to the first action performed by the controller node. The first indication enables the management node to perform a second action for handling the communication resources allocated to the one or more logical groups.

According to another aspect of embodiments herein, the object is achieved by a management node configured to handle communication resources allocated to one or more logical groups in a set of logical groups in a wireless communications network. The one or more logical groups are adapted to be controlled by a controller node associated to a control facility. One or more wireless devices are adapted to be associated to each logical group. The management node is further configured to:
allocate a communication resource to each one or more logical groups in the set of logical groups, wherein each wireless device is adapted to be associated to at least one logical group in the set of logical groups, and wherein each logical group is adapted to be associated with an operational process in the control facility,
monitor the allocated communication resource, by monitoring an available communication resource, a communication resource adapted to be currently used, and/or a communication resource required by one or more of the logical groups to perform the operational process adapted to be associated with the respective logical group,
receive from the controller node, a first indication, which first indication is adapted to be related to a first action performed by the controller node, and
perform a second action taking the received first indication and the monitored communication resource into account, for handling communication resources allocated to the one or more logical groups.

According to another aspect of embodiments herein, the object is achieved by a controller node configured to assist a management node in handling communication resources allocated to one or more logical groups in a set of logical groups in wireless communications network, which one or more logical groups are adapted to be controlled by the controller node associated to a control facility, wherein one or more wireless devices are adapted to be associated to each logical group, the controller node further being configured to:
perform a first action, which first action is adapted to be related to handling communication resources allocated to the one or more logical groups,
send to the management node, a first indication, which first indication is adapted to be related to the first action performed by the controller node, enabling the management node to perform a second action to handle the communication resources allocated to the one or more logical groups.

It is furthermore provided herein a computer program comprising instructions, which, when executed on at least one processor, cause the at least one processor to carry out the methods above, as performed by the management node and/or the controller node. It is additionally provided herein a computer-readable storage medium, having stored thereon a computer program comprising instructions which, when executed on at least one processor, cause the at least one processor to carry out the method according to the method above, as performed by the management node and/or the controller node.

Since the management node allocates a communication resources to each one or more logical groups of wireless devices, and monitors the allocated communication resources, it is possible for the management node to handle the communication resource allocated to the one or more logical groups of wireless devices. A controller node controlling the one or more logical groups, performs a first action related to assisting the management node in handling the communication resource and in response to the first action the management node performs a second action for handling the communication resource. In this way an efficient mechanism for handling a communication resource allocated to one or more logical groups is achieved, which in turn results in an improved flexibility and performance of the wireless communications network.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method in a management node.

FIG. 3 is a flowchart depicting embodiments of a method in a controller node.

FIG. 4a-c is a schematic block diagram illustrating embodiments herein,

FIG. 5a-b are schematic block diagrams illustrating embodiments of a management node.

FIG. 6a-b are schematic block diagrams illustrating embodiments of a controller node.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9-12 are flowcharts illustrating methods implemented in a communication system including a host computer, a base station and a user equipment.

### DETAILED DESCRIPTION

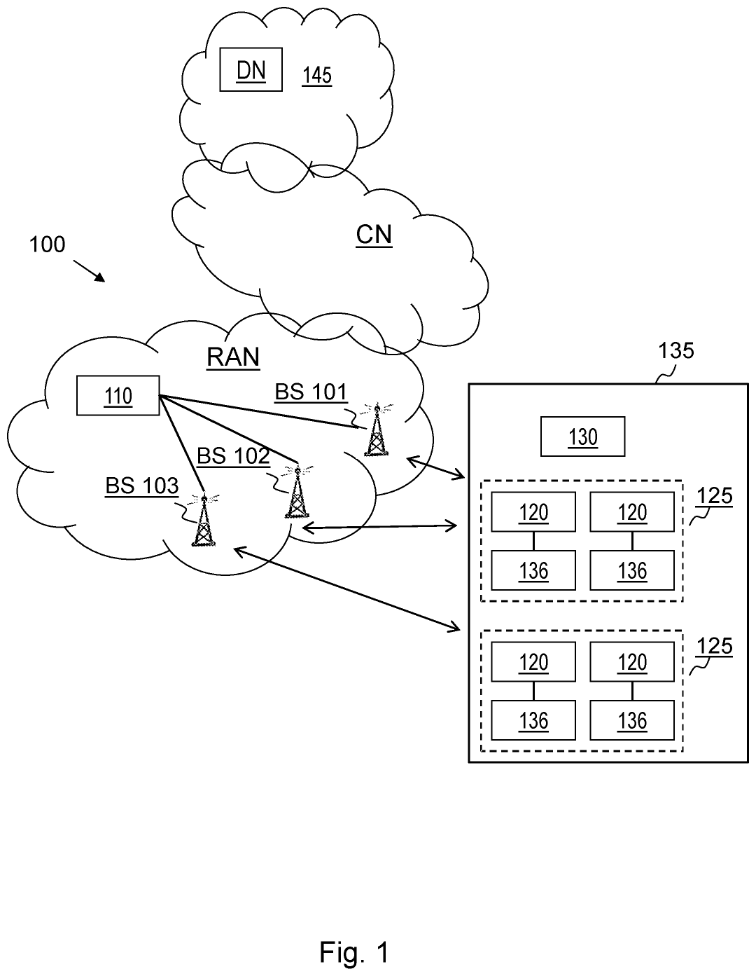

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a management node 110. Further a number of base stations such as e.g. a first base station 101, second base station 102 and a third base station 103 may operate in the wireless communications network. The base stations may be associated to the management node 110. The base stations 101, 102, 103, and in some embodiments the management node 110 provide radio coverage in a number of coverage areas in a cell, e.g. to a wireless device 120. The management node 110 may control the base stations 101, 102, 103. The management node 110 may be a base station, e.g. the first base station 101 or a stand-alone server. The management node 110, and the base stations 101, 102, 103, may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), agNB, a base transceiver station, a radio remote unit, an Access Point Base Station, a base station router, a transmission arrangement of a radio base station, a stand-alone access point or any other network unit capable of communicating with a wireless device within the service area served by the management node 110, and the base stations 101, 102, 103, depending e.g. on the radio access technology and terminology used. The management node 110, and the base stations 101, 102, 103, may be referred to as a serving radio network node and communicates with the wireless device 120 with Downlink (DL) transmissions to the wireless device 120 and Uplink (UL) transmissions from the wireless device 120.

In the wireless communication network 100, one or more wireless devices operate, such as e.g. the wireless device 120. The wireless device 120 may also referred to as a device, a terminal, an IoT device, a mobile station, a User equipment (UE), a robot, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

In the wireless communications network 100, one or more controller nodes may operate, such as a controller node 130. A controller node 130 when used herein may mean e.g. a factory main control unit and/or an industrial main control unit. A controller node such as e.g. the controller node 130, may be a network node for controlling an operational process in a control facility, e.g. the control facility 135. A control facility 135 when used herein may mean e.g. a factory and/or an industrial site. The controller node 130 may be associated to a control facility 135. The controller node 130 controls one or more logical groups 125, each logical group 125 comprising one or more wireless devices 120 associated to the logical group 125. Each logical groups 125 are associated with at least one operational process in the control facility 135. Each wireless device 120 is associated with at least one control facility device 136 performing the operational process. A control facility device 136 when used herein may mean e.g. an factory device or an industrial device. The wireless device 120 provides a connection to the wireless communications network 100 to each control facility device 136 it is associated to. The control facility may e.g. be an industrial site and/or a factory.

Methods herein may be performed by the management node 110 and the controller node 130. As an alternative, a Distributed Node (DN) and functionality, e.g. comprised in a cloud 145 as shown in FIG. 1, may be used for performing or partly performing the methods herein.

A number of embodiments will now be described, some of which may be seen as alternatives, while some may be used in combination.

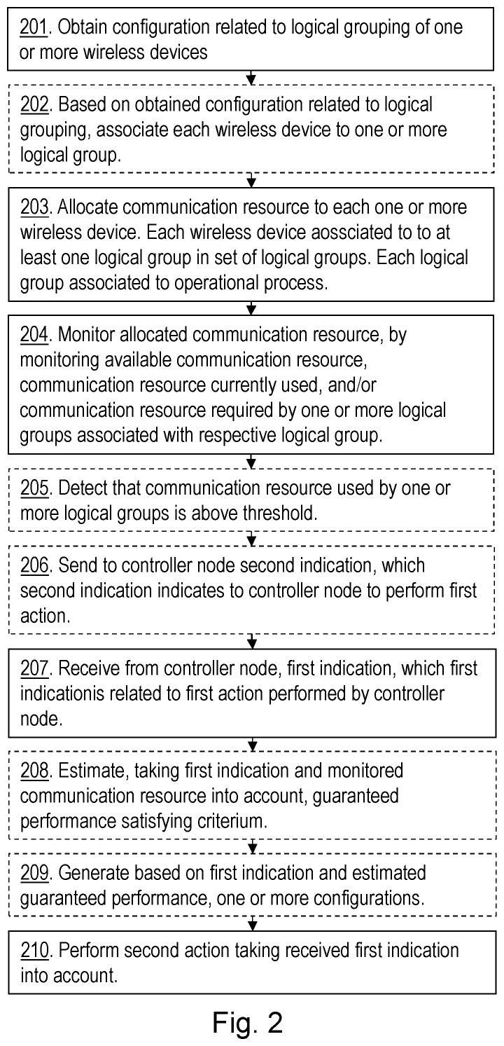

FIG. 2 shows example embodiments of a method performed by the management node 110 for handling communication resources allocated to one or more logical groups 125 in a set of logical groups in the wireless communications network 100. The one or more logical groups are controlled by the controller node 130. The controller node 130 is associated to the control facility 135. One or more wireless devices 120 is associated to each logical group 125. A control facility when used herein may mean e.g. a factory, a factory floor, an area on a factory floor and/or a construction site. A logical group when used herein may mean e.g. a group of wireless devices cooperating on similar tasks, having similar characteristics and/or located in close proximity to each other.

The method comprises the following actions, which actions may be taken in any suitable order. Optional actions are referred to as dashed boxes in FIG. 2.

Action 201. To group wireless devices, e.g. the one or more wireless devices 120, into logical groups, the management node 110 may obtain a grouping configuration. Therefore, in some embodiments, the management node 110 obtains a configuration related to a logical grouping of the one or more wireless devices 120 from the controller node 130.

Action 202. In some embodiments, based on the obtained configuration related to the logical grouping, the management node 110 associates each wireless device 120 with one or more logical groups 125 in a set of logical groups. The set of logical groups comprises one or more logical groups 125. Each logical group 125 is associated with an operational process in the control facility 135. An operational process when used herein may mean e.g. a task or action performed by a control facility device 136 associated to a wireless device 120.

Action 203. The management node 110 allocates a communication resource to each one or more logical groups 125 in the set of logical groups. Each wireless device 120 is associated with at least one logical group 125 in the set of logical groups. Each logical group 125 is associated with an operational process in the control facility 135. Allocating a communication resource may mean that each logical group 125 is allocated a certain amount of communication resources to be used for wireless communication. A communication resources may e.g. relate to a carrier, a bandwidth, a frequency, a minimum and/or maximum bitrate, a maximum amount data allowed to be transmitted during a pre-determined time period, scheduling of transmissions, scheduling priorities. By allocating the communication resource to the one or more logical groups 125, the wireless devices 120 associated with each of the logical groups 125 may communicate wirelessly with each other and the controller node 130. This allows the controller node 130 to e.g. provide instructions to the one or more wireless devices 120.

Action 204. To efficiently handle the communications resources, the management node 110 needs to keep track of the current status of the communications resources allocated to the one or more logical groups 125. The management node 110 monitors the allocated communication resource. The allocated communication resource is monitored by monitoring an available communication resource, a communication resource currently used, and/or a communication resource required by one or more of the logical groups 125 to perform the operational process associated with the respective logical group 125. By monitoring the allocated communication resources, the management node 110 may be able to detect problems, e.g. lack of capacity, and perform an action to solve the problem.

Action 205. In some embodiments, the management node 110 detects that communication resources used by one or more logical groups is above a threshold. The threshold may e.g. a certain percentage of the communication resources allocated to the logical group 125.

Action 206. In some embodiments, the management node 110 sends a second indication to the controller node 130. The second indication indicates to the controller node 130 to perform a first action. The second indication may further indicate the one or more logical groups 125 to which the used communication resources detected to be above threshold are allocated to. By indicating, e.g. instructing, the controller node 130 to perform the first action, the management node 110 is assisted in handing the communication resource efficiently. In some embodiments, the second indication further comprises a report related to available communication resources allocated to the one or more logical groups 125, which report is based on the monitored allocated communication resource. The report may indicate how much, e.g. a percentage, of the allocated resource each logical group 125 is using. The report may be used by the controller node 130 to perform actions for assisting the management node 110 to handle the allocated communication resources. The first action may comprise performing a negotiation between the management node 110 and the controller node 130 related to the resource allocation for the one or more logical groups 125. The negotiation may comprise the management node 110 and the controller node 130 negotiating e.g. allocation of resources, performance and/or quality of service requirements, performance and/or quality of service guarantees, and/or the operational status of one or more operational processes. The first action may further and/or alternatively comprise any one or more out of: stopping an operational process associated to one or more logical groups 125, decreasing a duty cycle and/or service requirement of an operational process associated to associated to one or more logical groups 125, accepting an adjusted allocation of communication resources, wherein the adjusted allocation comprises communication resources reserved for redundancy being allocated to be used by associated to one or more logical groups 125, and/or negotiating with the management node 110 the resource allocation for the one or more logical groups.

Action 207. The management node 110 receives a first indication from the controller node 130. The first indication is related to a first action performed by the controller node 130. The first action may be any one or more of the first actions indicated above. The first action enable the management node to handle the allocated communication resources by e.g. performing a second action, as described below. By obtaining information related to the first action performed by the controller node 130, the management node 110 may take an informed decision about a second action to perform. In some embodiments, the first indication further indicates any one out of: adjusted requirements related to the communication resource allocated to one or more of the logical groups 125, current requirements related to the communication resources associated to one or more of the logical groups 125, or predicted future requirements related to the communication resources associated to one or more of the logical groups 125.

Action 208. In some embodiments, the management node 110 estimates, taking the first indication and the monitored communication resource into account, a guaranteed performance satisfying a criterium. The criterium may e.g. be a guaranteed bite rate in uplink and/or downlink communications, a maximum latency and/or guaranteed throughput for uplink and/or downlink communications.

Action 209. In some embodiments, the management node 110 generates, based on the first indication and the estimated guaranteed performance satisfying a criteria, one or more configurations related to the communication resources allocated to the one or more of the logical groups 125. The one or more configurations may comprise different alternatives for allocation of communication resources to the one or more logical groups. The one or more configurations may further and/or alternatively comprise alternatives for which logical groups 125 to instruct to operate in idle mode, i.e. which operational processes to e.g. stop or turn off.

Action 210. The management node 110 performs a second action taking the received first indication and the monitored communication resource into account, for handling communication resources allocated to the one or more logical groups 125. In other words, the management may decide the second action to perform based on the first action performed by the controller node and the monitored communication resource. The second action may comprise performing a negotiation between the management node 110 and the controller node 130 related to the resource allocation for the one or more logical groups 125. As mentioned above, the negotiation may comprise the management node 110 and the controller node 130 negotiating e.g. allocation of resources, performance and/or quality of service requirements, performance and/or quality of service guarantees, and/or the operational status of one or more operational processes. In some embodiments, the second action comprise any one out of: determining a configuration out of the one or configurations to apply and applying the determined configuration, or sending to the controller node 130 the one or more configurations indicating to the controller node 130 to determine a configuration based on the one or more configurations to be applied, and receiving a determined configuration from the controller node 130. This allows a flexibility in determining the configuration to apply, by in some cases presenting the controller node 130 with different options to evaluate, and in some cases the management node 110 makes the determination. Which option to apply may depend on e.g. the impact the generated configuration may have on the operational processes in control facility. E.g. if there is a large impact, the management node 110 may decide to send the generated configurations to the controller node 130 to determine which one to apply. If the impact is minor, the management may determine the configuration to apply. The second action may further and/or alternatively, comprises any one or more out of: instructing the one or more wireless devices 120 associated to one or more logical groups 125 to operate in idle mode, changing a Quality of Service (QOS) requirement for the one or more wireless devices 120 associated to one or more logical groups 125, allocating communication resources reserved for redundancy to be used by one or more logical groups 125, negotiating with the controller node 130 the resource allocation for the one or more logical groups 125, and/or applying the determined configuration related to the communication resource allocated to one or more logical groups 125.

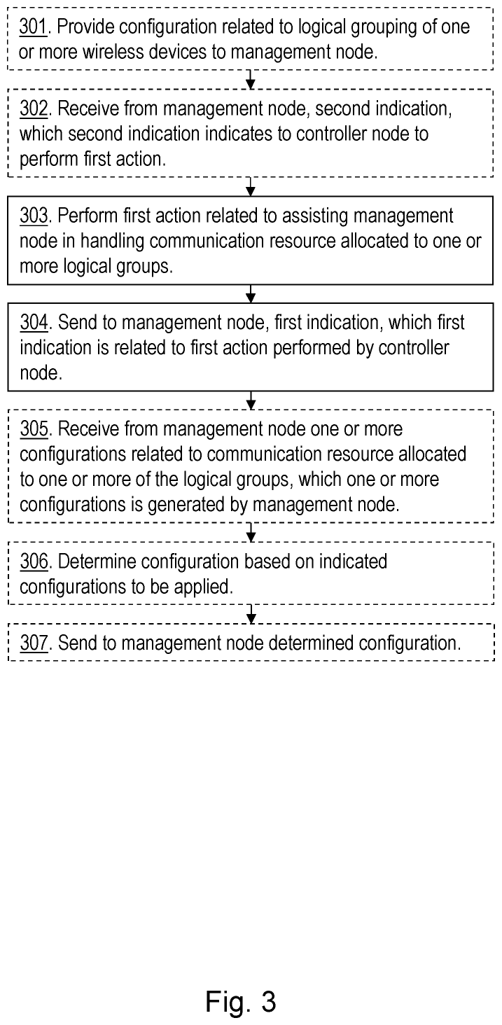

FIG. 3 shows example embodiments of a method performed by the controller node 130 for assisting the management node 110 in handling communication resources allocated to one or more logical groups 125 in a set of logical groups in wireless communications network 100. The one or more logical groups are controlled by the controller node 130. The controller node 130 is associated to the control facility 135. One or more wireless devices 120 is associated to each logical group 125. A control facility when used herein may mean e.g. a factory, a factory floor, an area on a factory floor and/or a construction site. A logical group when used herein may mean e.g. a group of wireless devices cooperating on similar tasks, having similar characteristics and/or located in close proximity to each other.

The method comprises the following actions, which actions may be taken in any suitable order. Optional actions are referred to as dashed boxes in FIG. 3.

Action 301. To group wireless devices, e.g. the one or more wireless devices 120, into logical groups, the controller node 130 may need provide a grouping configuration to the management node 110. Therefore, in some embodiments, the controller node 130 provides a configuration related to a logical grouping of the one or more wireless devices 120 from the controller node 130. The configuration associates each wireless device 120 to one or more logical groups 125 in the set of logical groups. The set of logical groups comprises one or more logical groups 125. Each logical group 125 is associated with an operational process in the control facility 135.

Action 302. In some embodiments, the controller node 130 receives a second indication from the management node 110. The second indication indicates to the controller node 130 to perform the first action. By receiving the indication, e.g. instruction, to perform the first action, the controller node 130 may is assist the management node 110 in handing the communication resource efficiently. In some embodiments, the second indication comprises a report related to available communication resources associated to the one or more logical groups, which report is based on an available communication resource, a communication resource currently used, and/or a communication resource required by one or more of the logical groups 125 to perform the operational process associated with the respective logical group (125) monitored by the management node 110. As mentioned above, the report may indicate how much, e.g. a percentage, of the allocated resource each logical group 125 is using. The report may be used by the controller node 130 to perform actions for assisting the management node 110 to handle the allocated communication resources.

Action 303. The controller node performs the first action. The first action is related to assisting the management node 110 in handling communication resources allocated to the one or more logical groups 125. In some embodiments, the first action comprises performing a negotiation between the management node 110 and the controller node 130 related to the resource allocation for the one or more logical groups. As mentioned above, the negotiation may comprise the management node 110 and the controller node 130 negotiating e.g. allocation of resources, performance and/or quality of service requirements, performance and/or quality of service guarantees, and/or the operational status of one or more operational processes. The first action may further and/or alternatively comprise any one or more out of: stopping an operational process associated to associated to one or more logical groups 125, decreasing a duty cycle and/or service requirement of an operational process associated to associated to one or more logical groups 125, accepting an adjusted allocation of communication resources, wherein the adjusted allocation comprises communication resources reserved for redundancy being allocated to be used by one or more logical groups 125, negotiating with the management node 110 the resource allocation for the one or more logical groups, and determining adjusted requirements related to the communication resource allocated to one or more of the logical groups 125, current requirements related to the communication resources associated to one or more of the logical groups 125 and/or predicted future requirements related to the communication resources associated to one or more of the logical groups 125.

Action 304. The controller node 130 sends the first indication to the management node 110. The first indication is related to the first action performed by the controller node 130. The first indication enables the management node 110 to perform the second action for handling the communication resources allocated to the one or more logical groups 125. The first action may be any one or more of the first actions indicated above. The first action enables the management node to handle the allocated communication resources by e.g. performing the second action. By providing information related to the first action performed by the controller node 130, the management node 110 may take an informed decision about the second action to perform. In some embodiments, the first indication further indicates any one out of: adjusted requirements related to the communication resource allocated to one or more of the logical groups 125, current requirements related to the communication resources associated to one or more of the logical groups 125, predicted future requirements related to the communication resources associated to one or more of the logical groups 125. In some embodiments, the second action comprises performing a negotiation between the management node 110 and the controller node 130 related to the resource allocation for the one or more logical groups. As mentioned above, the negotiation may comprise the management node 110 and the controller node 130 negotiating e.g. allocation of resources, performance and/or quality of service requirements, performance and/or quality of service guarantees, and/or the operational status of one or more operational processes. The second action, performed by the management node 110, may comprise any one or more out of: instructing the one or more wireless devices 120 associated to one or more logical groups 125 to operate in idle mode, changing a quality of service requirement for the one or more wireless devices 120 associated to one or more logical groups 125, allocating communication resources reserved for redundancy to be used by one or more logical groups 125, negotiating with the controller node 130 the resource allocation for the one or more logical groups 125, and applying the determined configuration related to the communication resources allocated to associated to one or more logical groups 125.

Action 305. In some embodiments, the controller node 130 receives from the management node 110 one or more configurations related to the communication resources allocated to the one or more of the logical groups 125. The one or more configurations are generated by the management node 110. The one or more configurations may be generated by the management node based on the first indication and the estimated guaranteed performance. The one or more configurations may comprise different alternatives for allocation of communication resources to the one or more logical groups. The one or more configurations may further and/or alternatively comprise alternatives for which logical groups 125 to instruct to operate in idle mode, i.e. which operational processes to e.g. stop or turn off.

Action 306. In some embodiments, the controller node 130 determines a configuration based on the indicated one or more configurations to be applied. This allows a flexibility in determining the configuration to apply, by allowing the controller node 130 to evaluate different alternative configurations. This allows the controller node 130 determine the configuration that optimize the operational process in the control facility.

Action 307. In some embodiments, the controller node 130 sends the determined configuration to the management node 110, enabling the management node 110 to apply the determined configuration for handling the communication resources allocated to the one or more logical groups 125.

Embodiments mentioned above will now be further described and exemplified. The text below is applicable to and may be combined with any suitable embodiment described above.

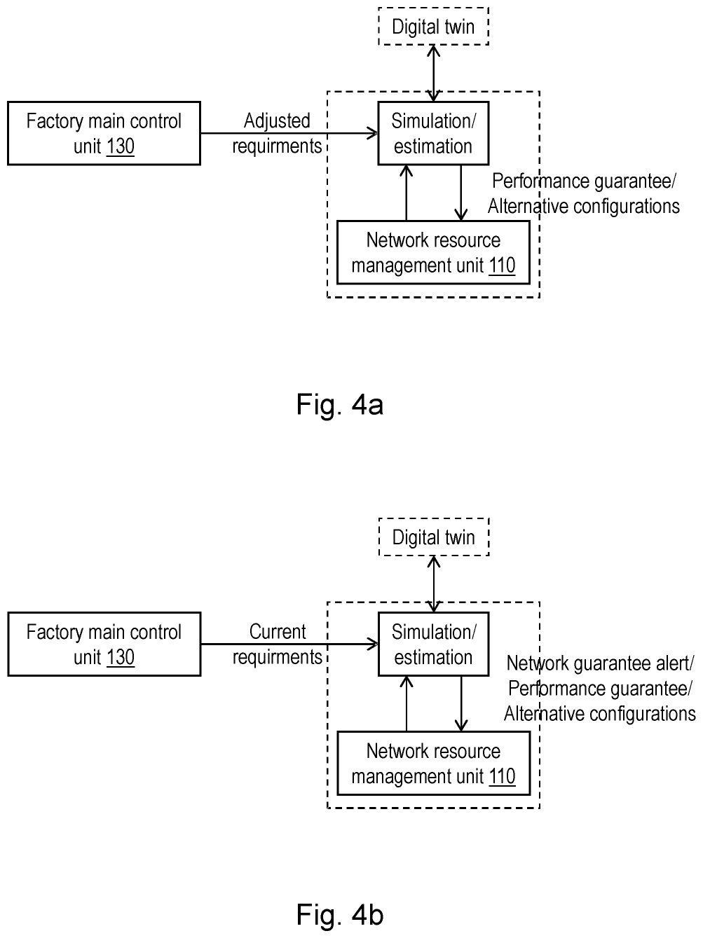

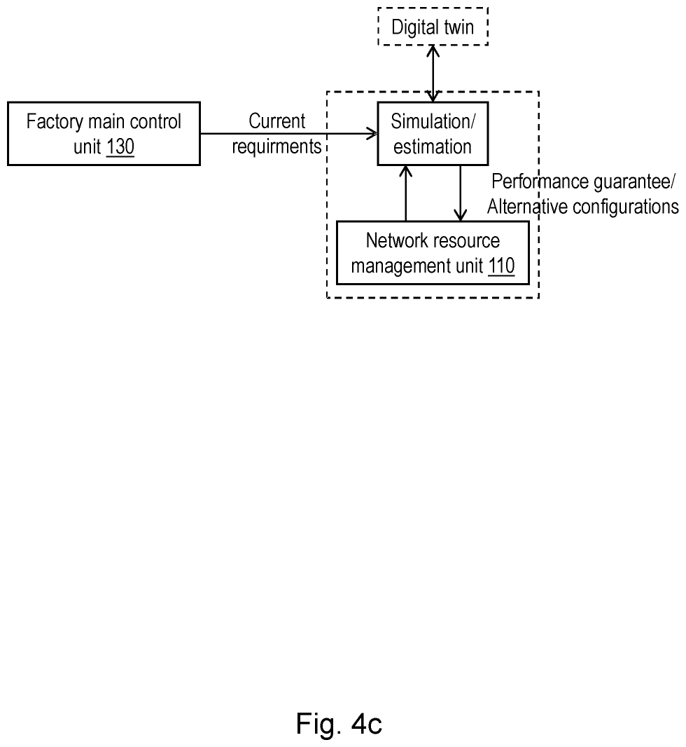

In FIG. 4a-c the management node 110 is referred to as network resource management unit 110 and the controller node 130 is referred to as factory main control unit 130.

When adding wireless devices, such as the one or more wireless devices 120 to the wireless communications network, each wireless device is assigned, such as associated, to at least one logical group, such as one or more of the one or more logical groups 125. Each logical group is associated to, e.g. serving and/or being part of, a manufacturing step and/or factory line, such as the operational process, in a factory or industrial site, such as the control facility 135. A network resource management unit 110, such as the management node 110, controls the wireless devices 120 in a logical group 125. The network resource management unit 110 monitors which sets of logical groups may be maintained simultaneously.

The network resource management unit 110 may discover a capacity problem for one logical group 125, such as detecting that communication resources used by one or more logical groups 125 is below a threshold. The network resource management unit 110 may send a signal, such as the second indication, to the factory main control unit 130, such as the controlled node 130, to temporarily turn off devices, such as control facility devices 136, corresponding to this logical group, e.g. turn off or stop a factory line or operational process. Further, corresponding wireless devices 120 associated the affected logical group may be switched over to idle mode to save radio resources, i.e. the network resource management unit 110 may perform the second action by instructing the one or more wireless devices associated to one or more logical groups 125 to operate in idle mode.

When load allows, such as when there are communication resources available, factory devices may be turned on again based on a negotiation between the network resource management unit 110 and the factory main control unit 130, and the network resource management unit 110 may instruct the wireless devices 120 to operate in connected mode.

When a decision is taken by the factory main control unit 130 and/or the network resource management unit 110 to turn off and/or stop one or more factory lines and/or operational processes, the factory main control unit 130 may start the turning on/off process and notify the network resource management unit 110 about it.

For turn off procedure, the factory main control unit 130 finalizes turning off the specific operational process and/or factory line, and then sends “turning off complete” notification to the network, such as sending the first indication. The network resource management unit 110 may force, such as instruct, the related logical group 125 of wireless devices 120 to operate in idle mode, disconnect the related logical group 125 of wireless devices 120 and/or change a quality of service profile for the related logical group 125 of wireless devices 120. The network resource management unit 110 may send a confirmation signal back to the factory main control unit 130.

For turn on procedure, the network resource management unit 110 may switch, such as instruct, the related logical group 125 of wireless devices 120 to operate in connected mode and/or upgrades their quality of service profile. Then the network resource management unit 110 may send a “connection complete” signal to the factory main control unit 130, which may then resume the related operational process and/or factory line.

In another example of embodiments herein, instead of turning off or stopping a factory line or operational process, the network resource management unit 110 may ask the factory control unit 130 to e.g. decrease a duty cycle and/or service requirement of one or more factory lines and/or operational processes. The one or more factory lines and/or operational processes being associated to the one or more logical groups 125.

In another example of embodiments herein, instead of turning off or stopping a factory line or operational process, redundancy may be traded for capacity. E.g. redundant infrastructure and/or spectrum could be, temporarily, used, such as allocated to the one or more logical groups 125, to increase network capacity, with, temporarily, reduced redundancy. One example may be that for redundancy purposes, two wireless devices 120 associated to one or more logical groups 125 may be allocated to provide communication resources to a control facility device 136 associated to a factory line and/or operational process. One of the two wireless devices 120 may then be reallocated in order to increase the available communication resources. Another example may be that one wireless device 120 associated to one or more logical groups 125 may be configured to use dual connectivity and/or carrier aggregation. By turning this off, the available communication resources may be increased. Yet another example may be that control facility devices 136 intended for redundancy may be turned off and/or reallocated in order to increase the available communication resources.

In another example of embodiments herein, in order to handle communication resources, an iterative negotiation process may be performed between the network resource management unit 110 and the factory main control unit 130. E.g. the network resource management unit 110 may periodically send capacity insights, such as the report related to available communication resources mentioned above, to the factory main control unit 130. The capacity insights, such as the report, may comprise a ratio of currently available resources in comparison with all communication resources allocated to logical groups 125 related to the factory main control unit 130. Or the capacity insights may comprise the percentage of all allocated communication resources each logical group 125 requires. The factory main control unit 130 may decide, such as determine, one or more factory line or operational process associated to one or more logical groups 125 to turn off or stop, decrease a duty cycle and/or decrease service requirement for. The factory main control unit 130 may further negotiate this with the network resource management node 110.

In an example of embodiments herein, a digital twin may be used. Simulations based on the digital twin may be used to for performing actions according to embodiments described herein. A digital twin when used herein may mean a virtual representation of a physical object, machine or system, for instance a holographic model of a robot, a virtual, and possibly, dynamic map or outline of a factory floor showing relevant machines and their related information.

In another example of embodiments herein, shown in FIG. 4a, the factory main control unit 130 may initiate a change in the allocated communication resources. The factory main control unit 130 may provide, such as by indicating in the first indication, adjusted requirements related to the communication resource allocated to at least one of the one or more logical groups 125, to the network resource management unit 110. The network resource management unit 110 provides, such as estimates, a guaranteed performance, e.g a guaranteed quality of service that may be provided considering the available and used allocated communication resources. The guaranteed performance may satisfy a criterium, which criterium may be based on the received adjusted requirements. The network resource management unit 110 may further provide, such as generate, estimate and/or calculate, possible alternative configurations, such as one or more configurations, for the communication resources allocated to the one or more logical groups 125. The generated configurations may be sent to the factory main control unit 130, which may determine which of the one or more configurations to apply. The factory main control unit 130 may send the determined configuration to the network resource management node 110, and the network resource management node 110 applies the determined configuration. Alternatively, the network resource management node 110 may determine a configuration from the generated configurations, and applies the determined configuration.

In another example of embodiments herein shown in FIG. 4b, the network resource management node 110 may initiate a change in the allocated communication resources. The network resource management node 110 may initiate the change in the allocated communication resources based on difficulties to guarantee a required network performance to all logical groups 125, such as detecting that communication resources used by one or more logical groups is above a threshold. The network resource management node 110 may send, such as by indicating in the second indication, a network guarantee alert to the factory main control unit 130. The factory main control unit 130 may in response provide, such as by indicating in the first indication, current requirement and/or priorities related to the communication resource allocated to at least one of the one or more logical groups to the network resource management unit 110. The network resource management unit 110 provides, such as estimates, a guaranteed performance, e.g a guaranteed quality of service that may be provided considering the available and used allocated communication resources. The guaranteed performance may satisfy a criterium, which criterium may be based on the received current requirements. The network resource management unit 110 may further provide, such as generate, estimate and/or calculate, possible alternative configurations, such as one or more configurations, for the communication resources allocated to the one or more logical groups. The generated configurations may be sent to the factory main control unit 130, which may determine which of the one or more configurations to apply. The factory main control unit 130 may send the determined configuration to the network resource management node 110, and the network resource management node 110 applies the determined configuration. Alternatively, the network resource management node 110 may determine a configuration from the generated configurations, and applies the determined configuration.

In another example of embodiments herein, shown in FIG. 4c, the network resource management node 110 and factory main control unit 130 negotiate changes based on high-level profiles and current resource situation. The network resource management unit 110 regularly, such as periodically, checks for possible alternatives for configurations, such as estimating the guaranteed performance and generating the one or more configurations for resource allocation to the one or more logical groups. The network resource management unit 110 negotiates with the factory main control unit 130 on the best network setup, such as negotiating which of the one or more generated configuration to apply.

In another example of embodiments herein, the above embodiments may comprise a machine learning process, such as an artificial intelligence, in the network resource management node 110. The machine learning process perform the generation of alternative configurations and/or negotiation of which configuration to apply. This may be continuously performed based patterns learning, e.g. via an intent-driven cognitive layer, which may call upon different intelligent agents to address the trade-off between the production intents and network constraints, and orchestrate the logical groups of wireless devices.

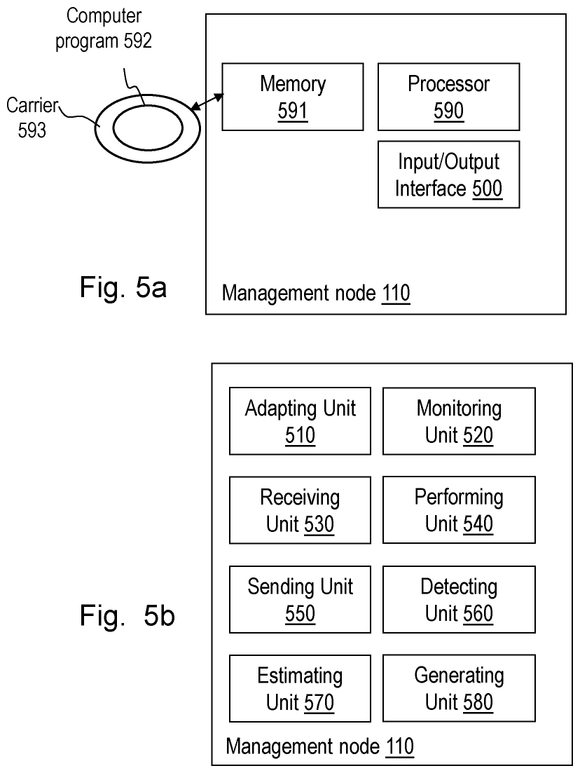

To perform the method actions above, the management node 110 is configured to handle communication resources allocated to one or more logical groups 125 in a set of logical groups in wireless communications network 100. The one or more logical groups 125 are adapted to be controlled by the controller node 130 adapted to be associated to the control facility 135. One or more wireless devices 120 are adapted to be associated to each logical group 125. The management node 110 may comprise an arrangement depicted in FIGS. 5a and 5b.

The management node 110 may comprise an input and output interface 500 configured to communicate the controller node 130, wireless devices such as the wireless device 120, and other network nodes in the wireless communications network 100. The input and output interface 500 may comprise a wireless receiver (not shown) and a wireless transmitter (not shown).

The management node 110 is further be configured to, e.g. by means of an allocating unit 510 in the management node 110, allocate a communication resource to each one or more logical groups 125 in the set of logical groups. Each wireless device 120 is adapted to be associated to at least one logical group 125 in the set of logical groups. Each logical group 125 is adapted to be associated with an operational process in the control facility 135.

The management node 110 is further be configured to, e.g. by means of a monitoring unit 520 in the management node 110, monitor the allocated communication resource, by monitoring an available communication resource, a communication resource currently used, and/or a communication resource required by one or more of the logical groups 125 to perform the operational process associated with the respective logical group 125.

The management node 110 is further be configured to, e.g. by means of a receiving unit 530 in the management node 110, receive from the controller node 130, a first indication. The first indication is adapted to be related to a first action performed by the controller node 130.

The first indication may be adapted to indicate any one or more out of: adjusted requirements related to the communication resource allocated to one or more of the logical groups 125, current requirements related to the communication resources associated to one or more of the logical groups 125, and predicted future requirements related to the communication resources associated to one or more of the logical groups 125.

The management node 110 is further be configured to, e.g. by means of a performing unit 540 in the management node 110, perform a second action taking the received first indication and the monitored communication resource into account, to handle communication resources allocated to the one or more logical groups 125.

The second action may be adapted to comprises any one or more out of: instruct the one or more wireless devices 120 adapted to be associated to one or more logical groups 125 to operate in idle mode, change a quality of service requirement for the one or more wireless devices 120 adapted to be associated to one or more logical groups 125, allocate communication resources adapted to be reserved for redundancy to be used by one or more logical groups 125, negotiate with the controller node 130 the resource allocation for the one or more logical groups 125, and apply the determined configuration adapted to be related to the communication resources allocated to one or more logical groups 125.

The second action may be adapted to comprise any one out of: determine a configuration out of the one or configurations to apply and apply the determined configuration, or send to the controller node 130 the one or more configurations adapted to indicate the controller node 130 to determine a configuration based on the one or more configurations to be applied, and receive a determined configuration from the controller node 130.

The management node 110 is further be configured to, e.g. by means of a sending unit 550 in the management node 110, send to the controller node 130, a second indication. The second indication is adapted to indicate to the controller node 130 to perform the first action.

The second indication may further be adapted to indicate the one or more logical groups.

The second indication may further be adapted to comprise a report related to available communication resources associated to the one or more logical groups the report is adapted to be based on the monitored communication resource.

The second action is adapted to comprise performing a negotiation between the management node 110 and the controller node 130 adapted to be related to the resource allocation for the one or more logical groups.

The first action is adapted to comprises any one or more out of: stop an operational process adapted to be associated to one or more logical groups 125, decrease a duty cycle and/or service requirement of an operational process adapted to be associated to one or more logical groups 125, accept an adjusted allocation of communication resources, wherein the adjusted allocation is adapted to comprise communication resources reserved for redundancy being allocated to be used by one or more logical groups 125, and negotiating with the management node 110 the resource allocation for the one or more logical groups.

The first action may be adapted to comprise performing a negotiation between the management node 110 and the controller node 130 adapted.

The management node 110 is further be configured to, e.g. by means of a detecting unit 560 in the management node 110, detect that communication resources used by one or more logical groups is above a threshold.

The management node 110 is further be configured to, e.g. by means of an estimating unit 570 in the management node 110, estimate, taking the first indication and the monitored communication resource into account, a guaranteed performance adapted to satisfy a criterium.

The management node 110 is further be configured to, e.g. by means of a generating unit 580 in the management node 110, generate based on the first indication and the estimated guaranteed performance satisfying a criterium, one or more configurations adapted to be related to the communication resources allocated to the one or more of the logical groups 125.

The embodiments herein may be implemented through a respective processor or one or more processors, such as the processor 590 of a processing circuitry in the management node 110 depicted in FIG. 5a, together with respective computer program code for performing the functions and actions of the embodiments herein. The program code mentioned above may also be provided as a computer program product, for instance in the form of a data carrier carrying computer program code for performing the embodiments herein when being loaded into the management node 110. One such carrier may be in the form of a CD ROM disc. It is however feasible with other data carriers such as a memory stick. The computer program code may furthermore be provided as pure program code on a server and downloaded to the management node 110.

The management node 110 may further comprise a memory 591 comprising one or more memory units. The memory 591 comprises instructions executable by the processor in management node 110. The memory 591 is arranged to be used to store e.g. actions, indication, configurations, parameters, requirements, performance criteria, data, information, thresholds and applications to perform the methods herein when being executed in the management node 110.

In some embodiments, a computer program 592 comprises instructions, which when executed by the respective at least one processor 590, cause the at least one processor 590 of the management node 110 to perform the actions above.

In some embodiments, a respective carrier 593 comprises the respective computer program 592, wherein the carrier 593 is one of an electronic signal, an optical signal, an electromagnetic signal, a magnetic signal, an electric signal, a radio signal, a microwave signal, or a computer-readable storage medium.

Those skilled in the art will appreciate that the units in the management node 110 described above may refer to a combination of analog and digital circuits, and/or one or more processors configured with software and/or firmware, e.g. stored in the management node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

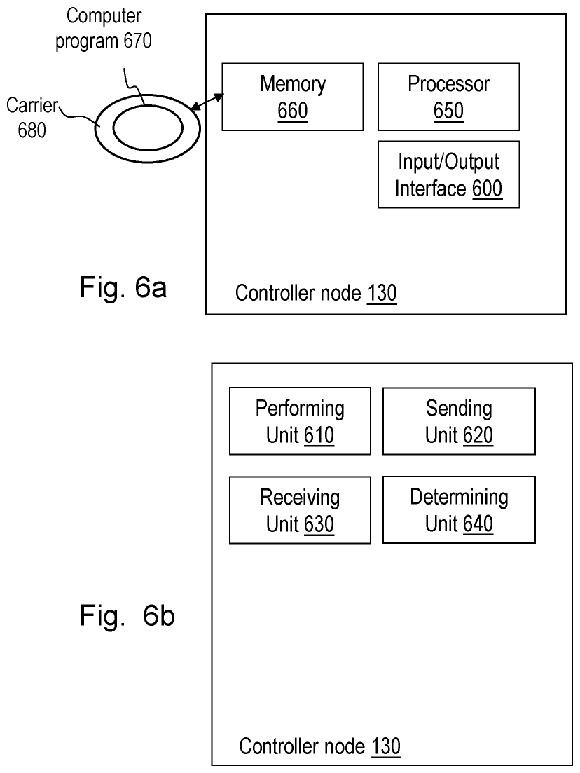

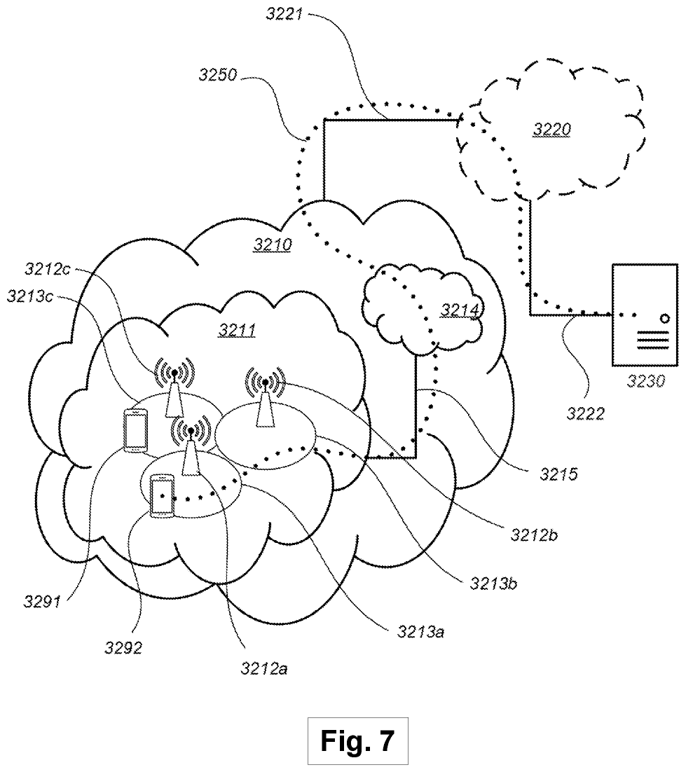

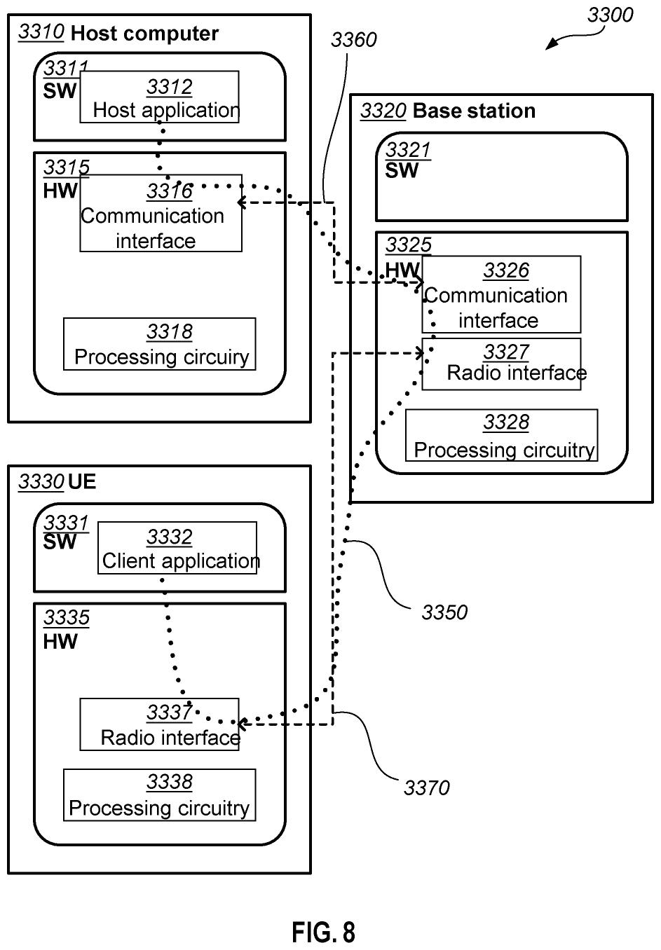

To perform the method actions above, the controller node 130 configured to assist a management node 110 in handling communication resources adapted to be allocated to one or more logical groups 125 in a set of logical groups in wireless communications network 100. The one or more logical groups 125 are adapted to be controlled by the controller node 130 adapted to be associated to a control facility 135. One or more wireless devices 120 are adapted to be associated to each logical group 125. The controller node 130 may comprise an arrangement depicted in FIGS. 6a and 6b.

The controller node 130 may comprise an input and output interface 600 configured to communicate the management node 110, wireless devices such as the wireless device 120, and other network nodes in the wireless communications network 100. The input and output interface 600 may comprise a wireless receiver (not shown) and a wireless transmitter (not shown).

The controller node 130 is further be configured to, e.g. by means of a performing unit 610 in the controller node 130, perform a first action. The first action is adapted to be related to assist the management node 110 in handling communication resources adapted to be allocated to the one or more logical groups 125.

The first action may be adapted to comprise performing a negotiation between the management node 110 and the controller node 130 related to the resource allocation for the one or more logical groups.

The first action may adapted to comprise any one or more out of: stop an operational process associated to one or more logical groups 125, decrease a duty cycle and/or service requirement of an operational process associated to associated to one or more logical groups 125, accept an adjusted allocation of communication resources, wherein the adjusted allocation is adapted to comprise communication resources reserved for redundancy being allocated to be used by one or more logical groups 125, negotiate with the management node 110 the resource allocation for the one or more logical groups, and determine adjusted requirements adapted to be related to the communication resource allocated to one or more of the logical groups 125, current requirements adapted to be related to the communication resources associated to one or more of the logical groups 125 and/or predicted future requirements adapted to be related to the communication resources associated to one or more of the logical groups 125.

The controller node 130 is further be configured to, e.g. by means of a sending unit 620 in the controller node 130, send to the management node 110, a first indication, which first indication is adapted to be related to the first action performed by the controller node 130, adapted to enable the management node 110 to perform a second action adapted to handle the communication resources adapted to be allocated to the one or more logical groups 125.

The second action may be adapted to comprise performing a negotiation between the management node 110 and the controller node 130 related to the resource allocation for the one or more logical groups.

The first indication may be adapted to indicate any one or more out of: adjusted requirements related to the communication resource allocated to one or more of the logical groups 125, current requirements related to the communication resources associated to one or more of the logical groups 125, and predicted future requirements related to the communication resources associated to one or more of the logical groups 125.

The second action may be adapted to comprise any one or more out of: instruct the one or more wireless devices 120 associated to one or more logical groups 125 to operate in idle mode, change a quality of service requirement for the one or more wireless devices 120 associated to one or more logical groups 125, allocate communication resources adapted to be reserved for redundancy to be used by one or more logical groups 125, negotiate with the controller node 130 the resource allocation for the one or more logical groups 125, and apply the determined configuration adapted to be related to the communication resources adapted to be allocated to associated to one or more logical groups 125.

The controller node 130 is further be configured to, e.g. by means of the sending unit 620 in the controller node 130, send to the management node 110 the determined configuration, adapted to enable the management node 110 to apply the determined configuration to handle the communication resources adapted to be allocated to the one or more logical groups 125.

The controller node 130 is further be configured to, e.g. by means of a receiving unit 630 in the controller node 130, receive from the management node 110, a second indication. The second indication is adapted to indicate to the controller node 130 to perform the first action.

The second indication may be adapted to comprise a report related to available communication resources adapted to be allocated to the one or more logical groups. The report is adapted to be based on an available communication resource, a communication resource currently used, and/or a communication resource required by one or more of the logical groups 125 to perform the operational process adapted to be associated with the respective logical group 125 monitored by the management node 110. and

The controller node 130 is further be configured to, e.g. by means of the receiving unit 630 in the controller node 130, receive, from the management node 110, one or more configurations adapted to be related to the communication resources adapted to be allocated to the one or more of the logical groups 125. The one or more configurations are adapted to be generated by the management node 110.

The controller node 130 is further be configured to, e.g. by means of a determining unit 640 in the controller node 130, determine a configuration, adapted to be based on the indicated configurations, to be applied.

The embodiments herein may be implemented through a respective processor or one or more processors, such as the processor 650 of a processing circuitry in the controller node 130 depicted in FIG. 6a, together with respective computer program code for performing the functions and actions of the embodiments herein. The program code mentioned above may also be provided as a computer program product, for instance in the form of a data carrier carrying computer program code for performing the embodiments herein when being loaded into the controller node 130. One such carrier may be in the form of a CD ROM disc. It is however feasible with other data carriers such as a memory stick. The computer program code may furthermore be provided as pure program code on a server and downloaded to the controller node 130.

The controller node 130 may further comprise a memory 660 comprising one or more memory units. The memory 660 comprises instructions executable by the processor in controller node 130. The memory 660 is arranged to be used to store e.g. actions, indication, configurations, parameters, requirements, performance criteria, data, information, thresholds and applications to perform the methods herein when being executed in the controller node 130.

In some embodiments, a computer program 670 comprises instructions, which when executed by the respective at least one processor 650, cause the at least one processor 650 of the controller node 130 to perform the actions above.

In some embodiments, a respective carrier 680 comprises the respective computer program 670, wherein the carrier 680 is one of an electronic signal, an optical signal, an electromagnetic signal, a magnetic signal, an electric signal, a radio signal, a microwave signal, or a computer-readable storage medium.

Those skilled in the art will appreciate that the units in the controller node 130 described above may refer to a combination of analog and digital circuits, and/or one or more processors configured with software and/or firmware, e.g. stored in the controller node 130, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

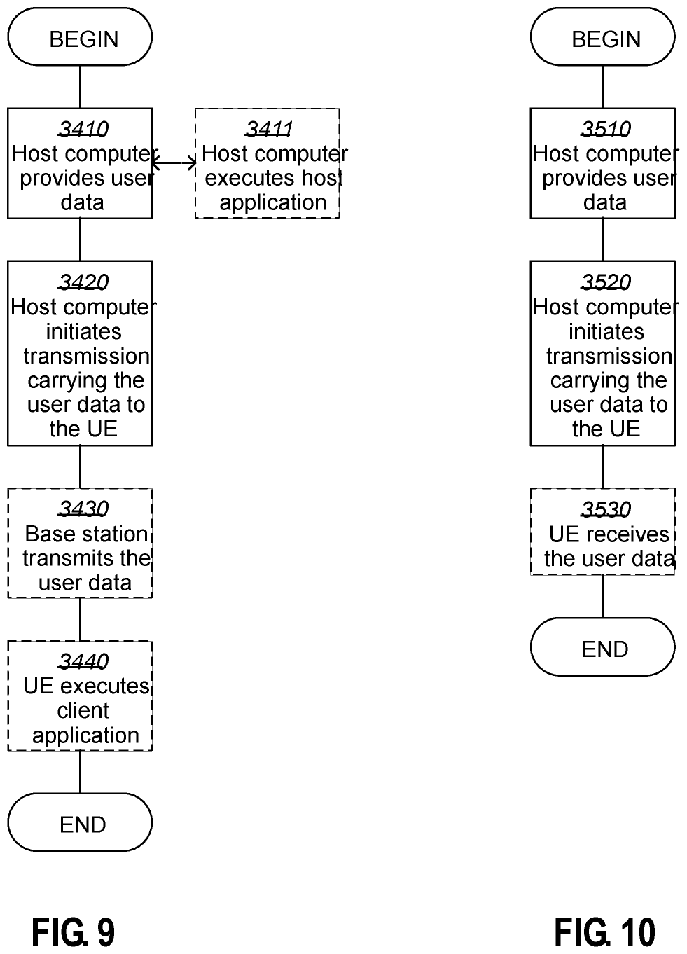

With reference to FIG. 9, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

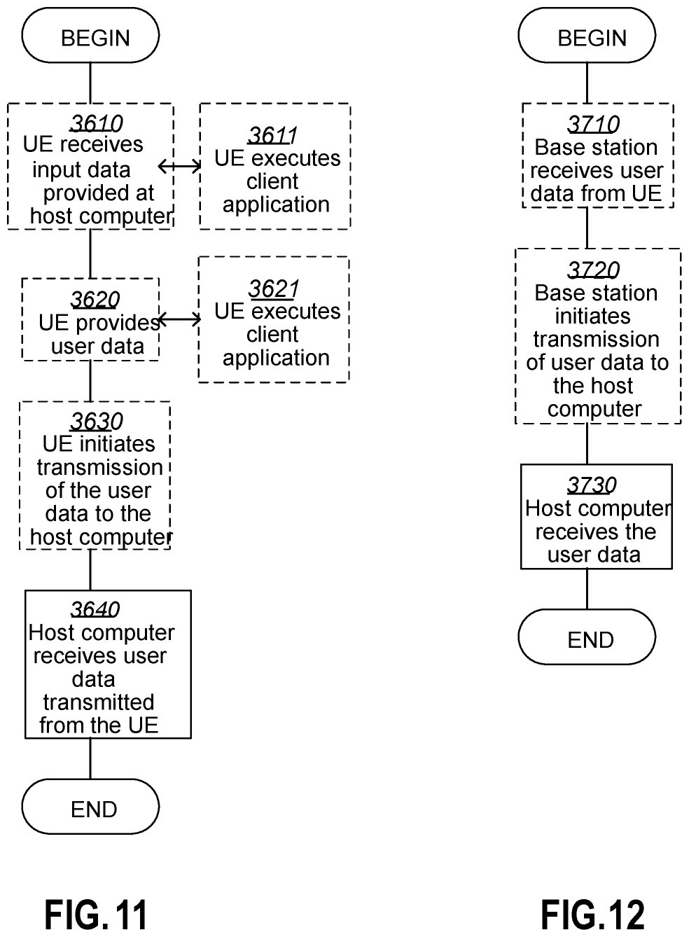

FIG. 11 is a flowchart illustrating a method implemented in a communication system, in accordance with one embodiment. The communication system includes a host computer, a base station such as the network node 112, and a UE such as the UE 120, which may be those described with reference to FIG. 9 and FIG. 10. For simplicity of the present disclosure, only drawing references to FIG. 11 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 12 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 13 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a management node for handling communication resources allocated to one or more logical groups in a set of logical groups in a wireless communications network, which one or more logical groups are controlled by a controller node associated to a control facility, one or more wireless devices being associated to each logical group, the method comprising:
allocating a communication resource to each one or more logical groups in the set of logical groups, each wireless device is being associated to at least one logical group in the set of logical groups, and each logical group is associated with an operational process in the control facility;
monitoring the allocated communication resource, by monitoring an available communication resource, a communication resource currently used, and/or a communication resource required by one or more of the logical groups to perform the operational process associated with the respective logical group;
receiving from the controller node, a first indication, which first indication is related to a first action performed by the controller node; and
performing a second action taking the received first indication and the monitored communication resource into account, for handling communication resources allocated to the one or more logical groups.

2. The method according to claim 1, the method further comprising:
sending to the controller node, a second indication, which second indication indicates to the controller node to perform the first action.

3. The method according to claim 2, further comprising:
detecting that communication resources used by one or more logical groups is above a threshold; and
wherein the second indication further indicates the one or more logical groups.

4. The method according to claim 2, wherein the second indication comprises a report related to available communication resources associated to the one or more logical groups, which report is based on the monitored allocated communication resource; and
wherein the second action and the first action comprises performing a negotiation between the management node and the controller node related to the resource allocation for the one or more logical groups.

5. The method according to claim 1, the method further comprising:
estimating, taking the first indication and the monitored communication resource into account, a guaranteed performance satisfying a criteria;
generating based on the first indication and the estimated guaranteed performance satisfying the criteria, one or more configurations related to the communication resources allocated to the one or more of the logical groups;
wherein the second action comprises any one out of:
determining a configuration out of the one or configurations to apply and applying the determined configuration; and
sending to the controller node the one or more configurations indicating to the controller node to determine a configuration based on the one or more configurations to be applied, and receiving a determined configuration from the controller node.

6. The method according to claim 1, wherein the first indication indicates any one or more out of:
adjusted requirements related to the communication resource allocated to one or more of the logical groups;
current requirements related to the communication resources associated to one or more of the logical groups; and
predicted future requirements related to the communication resources associated to one or more of the logical groups.

7. The method according to claim 1, wherein the second action comprises any one or more out of:
instructing the one or more wireless devices associated to one or more logical groups to operate in idle mode;
changing a Quality of Service, QoS, requirement for the one or more wireless devices associated to one or more logical groups;
allocating communication resources reserved for redundancy to be used by one or more logical groups;
negotiating with the controller node the resource allocation for the one or more logical groups; and
applying the determined configuration related to the communication resources allocated to one or more logical groups.

8. The method according to claim 1, wherein the first action comprises any one or more out of:
stopping an operational process associated to one or more logical groups;
decreasing one or both of a duty cycle and service requirement of an operational process associated to one or more logical groups;
accepting an adjusted allocation of communication resources, wherein the adjusted allocation comprises communication resources reserved for redundancy being allocated to be used by associated to one or more logical groups;
negotiating with the management node the resource allocation for the one or more logical groups; and
determining one or more of adjusted requirements related to the communication resource allocated to one or more of the logical groups, current requirements related to the communication resources associated to one or more of the logical groups and predicted future requirements related to the communication resources associated to one or more of the logical groups.

9. (canceled)

10. (canceled)

11. A method performed by a controller node for assisting a management node in handling communication resources allocated to one or more logical groups in a set of logical groups in wireless communications network, which one or more logical groups are controlled by the controller node associated to a control facility, one or more wireless devices is being associated to each logical group, the method comprising:
performing a first action, which first action is related to assisting the management node in handling communication resources allocated to the one or more logical groups; and
sending to the management node, a first indication, which first indication is related to the first action performed by the controller node, enabling the management node to perform a second action for handling the communication resources allocated to the one or more logical groups.

12. The method according to claim 11, the method further comprising:
receiving from the management node, a second indication, which second indication indicates to the controller node to perform the first action.

13. The method according to claim 12, wherein the second indication comprises a report related to available communication resources associated to the one or more logical groups, which report is based on one or more of an available communication resource, a communication resource currently used, and a communication resource required by one or more of the logical groups to perform the operational process associated with the respective logical group monitored by the management node; and
wherein the second action and the first action comprises performing a negotiation between the management node and the controller node related to the resource allocation for the one or more logical groups.

14. The method according to claim 11, wherein the method further comprises:
receiving from the management node one or more configurations related to the communication resources allocated to the one or more of the logical groups, which one or more configurations are generated by the management node;
determining a configuration based on the indicated configurations to be applied; and
sending to the management node the determined configuration, enabling the management node to apply the determined configuration for handling the communication resources allocated to the one or more logical groups.

15. The method according to claim 11, wherein the first indication indicates any one or more out of:
adjusted requirements related to the communication resource allocated to one or more of the logical groups;
current requirements related to the communication resources associated to one or more of the logical groups; and
predicted future requirements related to the communication resources associated to one or more of the logical groups.

16. The method according to claim 11, wherein the second action comprises any one or more out of:
instructing the one or more wireless devices associated to one or more logical groups to operate in idle mode;
changing a Quality of Service requirement for the one or more wireless devices associated to one or more logical groups;
allocating communication resources reserved for redundancy to be used by one or more logical groups;
negotiating with the controller node the resource allocation for the one or more logical groups; and
applying the determined configuration related to the communication resources allocated to associated to one or more logical groups.

17. The method according to claim 11, wherein the first action comprises any one or more out of:
stopping an operational process associated to one or more logical groups,
decrease one or both of a duty cycle and service requirement of an operational process associated to one or more logical groups;
accepting an adjusted allocation of communication resources, wherein the adjusted allocation comprises communication resources reserved for redundancy being allocated to be used by one or more logical groups;
negotiating with the management node the resource allocation for the one or more logical groups; and
determining one or more of adjusted requirements related to the communication resource allocated to one or more of the logical groups, current requirements related to the communication resources associated to one or more of the logical groups and predicted future requirements related to the communication resources associated to one or more of the logical groups.

18. (canceled)

19. (canceled)

20. A management node configured to handle communication resources allocated to one or more logical groups in a set of logical groups in wireless communications network, which one or more logical groups are adapted to be controlled by a controller node adapted to be associated to a control facility, one or more wireless devices being adapted to be associated to each logical group, the management node further being configured to:
allocate a communication resource to each one or more logical groups in the set of logical groups, each wireless device is being adapted to be associated to at least one logical group in the set of logical groups, and each logical group is adapted to be associated with an operational process in the control facility;
monitor the allocated communication resource, by monitoring one or more of an available communication resource, a communication resource currently used, and a communication resource required by one or more of the logical groups to perform the operational process associated with the respective logical group;
receive from the controller node, a first indication, which first indication is adapted to be related to a first action performed by the controller node; and
perform a second action taking the received first indication and the monitored communication resource into account, to handle communication resources allocated to the one or more logical groups.

21. The management node according to claim 20, further configured to:
send to the controller node, a second indication, which second indication is adapted to indicate to the controller node to perform the first action.

22. The management node according to claim 21, further configured to:
detect that communication resources used by one or more logical groups is above a threshold; and
wherein the second indication further is adapted to indicate the one or more logical groups.

23.-27. (canceled)

28. A controller node configured to assist a management node in handling communication resources adapted to be allocated to one or more logical groups in a set of logical groups in wireless communications network, which one or more logical groups are adapted to be controlled by the controller node adapted to be associated to a control facility, one or more wireless devices being adapted to be associated to each logical group, controller node further being configured to:
perform a first action, which first action is adapted to be related to assist the management node in handling communication resources adapted to be allocated to the one or more logical groups; and
send to the management node, a first indication, which first indication is adapted to be related to the first action performed by the controller node, adapted to enable the management node to perform a second action adapted to handle the communication resources adapted to be allocated to the one or more logical groups.

29. The controller node according to claim 28, wherein the controller node is further configured to:
receive from the management node, a second indication, which second indication is adapted to indicate to the controller node to perform the first action.

30.-34. (canceled)
